(19) United States
(12) Patent Application Publication
(10) Pub. No.: US 2023/0393028 A1
(43) Pub. Date: Dec. 7, 2023

(54) AUTHENTICATABLE SAMPLE COLLECTION KIT FOR PLANT SAMPLE COLLECTION AND USE THEREOF

(71) Applicants: Fraunhofer-Gesellschaft zur Foerderung der angewandten Forschung e. V., Muenchen (DE); Universitaet des Saarlandes, Saarbruecken (DE)

(72) Inventor: Heiko ZIMMERMANN, Sulzbach (DE)

(21) Appl. No.: 18/032,095

(22) PCT Filed: Nov. 12, 2021
(86) PCT No.: PCT/EP2021/081498

§ 371 Date: Apr. 14, 2023

(30) Foreign Application Priority Data
Nov. 13, 2020 (DE) 10 2020 130 008.5

(51) Int. Cl. G01N 1/04; B01L 3/00; H04L 9/40

(52) U.S. Cl. CPC G01N 1/04; B01L 3/54; H04L 63/0853; B01L 2300/023

(57) ABSTRACT

A sample collection kit for collecting plant samples, in particular algae samples for biomedical applications, comprises at least one sample container adapted to receive plant samples, a sensor arrangement having multiple sensors that can be used to capture sample data, a data recording device adapted to record the sample data, a tool arrangement having collection tools, which are adapted for harvesting the plant samples, and having processing tools, which are adapted for processing the plant samples, a container device adapted to receive the tool arrangement and the de-vice arrangement in a state that is isolated from the surroundings, and identification markings that include identification data and are attached to the at least one sample container, the collection tools and the processing tools, wherein there is provision for an authentication device that contains an electronically readable data carrier containing authentication data that represent a state of the sample collection kit, and the authentication device is attached to at least one from the container device, the at least one sample container, the collection tools and the processing tools. An authentication arrangement and a method for testing a state of a sample collection kit are also described.

The invention relates to a sample collection kit adapted for collecting plant samples, in particular for collecting algae samples for biomedical applications. Furthermore, the invention relates to an authentication arrangement and a method for testing a state of the sample collection kit. The invention may be used with collecting samples for obtaining plant extracts, in particular for biomedical applications, for example, for obtaining alginate granules.

Obtaining alginate from natural algae samples is generally known. Alginate has numerous biomedical applications, like, for example, in manufacturing implants or in cell biology. In particular, for these applications a particular purity of the alginate and a reproducible process chain from the outdoor collection of the algae up to obtaining and processing of alginate in the laboratory are required.

EP 3 257 586 A1 (“Sample collection kit and method for plant sample collection, in particular of algae samples”) describes a sample collection kit applicable throughout the complete process chain from the outdoor collection of the algae up to the processing in the laboratory. The sample collection kit is used in all phases of the process chain and thus allows complying with reproducibility of the process chain.

However, practical experiences show that alginates, even if the same are collected and processed with the sample collection kit according to EP 3 257 586 A1, may still show undesirable fluctuations of biofunctionality. It was noted that despite checking the sample collection kits before their application and strict compliance of harvesting and transport conditions, requirements for the approval of plant products for medical applications, in particular guidelines for quality assurance of production flows and surroundings (for example, GM P, “Good Manufacturing Practice”), cannot always be reliably fulfilled.

The mentioned problems not only occur in the collection of algae and obtaining alginate, but also in collecting other plant samples, for example, for the production of active ingredients.

The objective of the invention is to provide an improved sample collection kit for collecting plant samples, in particular algae samples, as well as an improved device and an improved method, respectively, for testing a state of a sample collection kit, by which disadvantages of conventional techniques can be avoided. In particular, the sample collection kit and the testing of its state should allow the application of sample collection kits and/or obtaining alginate with an increased reliability and reproducibility of collecting and processing the algae. Furthermore, in particular the compliance with standards for quality assurance, such as GMP standards, should be further improved.

This objective is achieved by a sample collection kit, an authentication arrangement and a method for testing a state of the sample collection kit, respectively, having the features of the independent claims. Advantageous embodiments and applications of the invention result from the dependent claims.

According to a first general aspect of the invention the above-mentioned objective is achieved by a sample collection kit adapted for collecting plant samples, in particular algae samples for biomedical applications. The sample collection kit comprises at least one sample container adapted to receive plant samples, a sensor arrangement having multiple sensors that can be used to capture sample data, a data recording device adapted to record the sample data, a tool arrangement having collection tools, which are adapted for harvesting the plant samples, and having processing tools, which are adapted for processing the plant samples, a container device adapted to receive the tool arrangement and the device arrangement in a state that is isolated from the surroundings, and identification markings that include identification data and are attached to the at least one sample container, the collection tools and the processing tools. Optionally, a device arrangement having auxiliary devices may be further provided, which are usable in the collection, transport and processing of the plant samples. The identification markings comprise, for example, barcodes, QR codes, wireless readable memories, in particular transponders and/or strings of numbers and/or characters, preferably in a waterproof form, containing the identification data.

According to the invention, the sample collection kit further comprises an authentication device that includes an electronically readable data carrier (data memory) containing authentication data that represent a state of the sample collection kit, wherein the authentication device is attached to at least one of the container device, the at least one sample container, the collection tools and the processing tools. Preferably, the data carrier is coupled to an interface to read out the authentication data. The interface may be part of the authentication device or a different component of the sample collection kit. The sample collection kit may include one single or multiple authentication device(s).

According to a second general aspect of the invention the above-mentioned objective is achieved by an authentication arrangement adapted for testing a state of the sample collection kit according to the first general aspect of the invention or an embodiment of the sample collection kit, and contains the sample collection kit containing the authentication device, and a test device adapted for reading out the authentication data and for authentication of the sample collection kit.

According to a third general aspect of the invention the above-mentioned objective is achieved by a method for testing a state of the sample collection kit according to the first general aspect of the invention or an embodiment of the sample collection kit, comprising the steps of reading out the authentication data and authenticating the sample collection kit with a test device, and generating a control signal, by which at least one of an alarm system, a mechanical blocking device and an electronic blocking device is activatable, depending on an authentication based on the authentication data. The method for testing the state of the sample collection kit may be carried out once before starting the application or as required during the application, or a plurality of times in different phases of the application of the sample collection kit, or continuously during the application of the sample collection kit.

The authentication comprises the verification of the authenticity and usability of the sample collection kit according to the authentication data. Preferably, a comparison of the authentication data with reference data of a genuine (originally manufactured) ready for use sample collection kit is carried out. As a result of the authentication the control signal is preferably generated. It may be provided that the control signal is generated as a blocking signal only in case of a negative result. Alternatively, it may be provided that the control signal is generated in any case, i.e., as an enabling signal in case of a positive result and as a blocking signal in case of a negative result.

Investigations by the inventors have shown that in the practical application a user may use a conventional sample collection kit, for example, according to EP 3 257 586 A1, at the collection location beyond a predetermined shelf-life. Furthermore, the inventors have found that the application of a kit, in particular of its tools and/or chemical treatment agents, beyond the shelf-life may have a negative impact on obtaining the plant samples. Furthermore, it has been noted that a sample collection kit may be newly assembled from parts of used kits and/or falsified parts in an unauthorized manner, which may be confused with an originally manufactured sample collection kit. Sample collection kits overaged and/or assembled in an unauthorized manner may compromise the overall system, since they result in that plant samples, in particular alginate, are generated under non-reproducible conditions, and in most unfavorable case, even contaminated.

By providing a sample collection kit with an authentication device according to the invention, the process chain from collecting plants up to obtaining and processing of plant samples from the plants can be protected against falsifications or user mistakes in an advantageous manner. The authentication device allows reading out of the authentication data and the authentication of the sample collection kit with the test device in an advantageous manner. A particular advantage of the authentication is that the application of falsified and/or overaged sample collection kits is excluded.

In the conventional sample collection kit, identification markings are already provided, by which respective parts of the sample collection kit are identifiable. The identification allows a correlation of the components in the sample collection kit to the actually obtained plant samples. However, in contrast to the additionally provided authentication device according to the present invention, the conventional identification markings do not include information with respect to the state of the sample collection kit as a whole. The term “state of the sample collection kit” relates to the overall configuration of the sample collection kit as a connection of its components. The information of the, preferably all, identification markings may be included in the authentication data.

The sample collection kit obtains a new functionality by the authentication device. Depending on the result of the authentication, the application of the sample collection kit may be enabled (or continued) or disabled (or stopped).

The authentication device is preferably provided additionally to the identification markings. The data carrier of the authentication device is particularly preferable provided separately from the identification markings. In case the identification markings also comprise an electronically readable data carrier, the authentication device is preferably separated from the identification markings in an electrical and/or software-based manner. The data carrier of the authentication device forms a so-called “secure enclave” data memory. The authentication device is preferably also arranged separately from an optionally provided control device of the sample collection kit in an electrical and/or software-based manner. An access of the control device to the authentication device is particularly preferable excluded. The authentication device is preferably a ROM memory.

According to a preferred embodiment of the invention, the authentication data of the electronically readable data carrier of the authentication device represent at least one of an original configuration of the sample collection kit and an expiration date of the sample collection kit. Said authentication data allow in an advantageous manner to check whether the original components in the sample collection kit match with an original configuration and/or whether a predetermined service life of the sample collection kit is exceeded. Thereby the most important application errors by users may be monitored and excluded in an advantageous manner.

The authentication data of the electronically readable data carrier of the authentication device particularly preferable comprise both information about the original configuration of the sample collection kit and the expiration date of the sample collection kit. According to a preferred embodiment of the method according to the present invention, the authentication of the sample collection kit may comprise a two-step authentication having a first test of the original state of the at least one sample collection kit and an expiration date of the sample collection kit, and a second test of the matching of parts of the sample collection kit. The test device of the authentication arrangement is preferably adapted for the two-step authentication. The first test preferably compares the stored information of the information markings with data of original components. The second test preferably compares the total of the data of the original components with a predetermined original configuration and its service life. In case of negative test results the authentication result is negative.

According to a further preferred embodiment of the invention the authentication device is adapted for a storage of encrypted authentication data. By the encryption, an unauthorized circumvention of the monitoring of the sample collection kit by users is excluded in an advantageous manner. The authentication data cannot be falsified or changed by users. It is particularly preferred to provide a cryptographic encryption of the authentication data.

The test device of the authentication arrangement is preferably adapted for decryption of the authentication data. The test device may carry out the decryption immediately between the read-out of the authentication data and the authentication of the sample collection kit in an advantageous manner.

The authentication device may be adapted for a wired access to the authentication data, in particular for a wired read-out of the authentication data in an advantageous manner. In this case, the data carrier of the authentication device is provided with a conductor interface, like, for example, a plug connection, in order to provide a connection with a test device and to analyze the stored authentication data. Thus, an unauthorized wireless access to the data carrier is excluded in an advantageous manner.

Alternatively or additionally, the authentication device may be adapted for a wireless access to the authentication data, in particular for a wireless read-out of the authentication data. In this case, advantages are provided by a fast testing of the sample collection kit and/or the possibility of parallelizing the testing of a plurality of sample collection kits.

A further advantage of the invention is that different types of authentication devices are applicable. According to preferred variants, the authentication device comprises at least one of at least an RFID beacon, at least a mobile radio SIM card, at least one WLAN transmission-receiving unit, a satellite telephone unit and at least one Bluetooth beacon. These types of authentication devices have particular advantages concerning the wireless read-out of the authentication data by using an available, robust and optionally cheap technique.

According to a particularly preferred embodiment of the invention, the authentication device is arranged in a hidden manner and is not visible when using the sample collection kit. The authentication device is preferably mounted in the sample collection kit, in particular in the material of at least one of its components, such that the authentication device is fully, or apart from the optionally provided connector interface, almost fully covered by the material. The authentication device may be, for example, embedded in a plastic material of a kit component. Thereby the authentication device is not recognizable by the user and/or protected against an unauthorized removal or replacement in an advantageous manner.

Alternatively or additionally, the authentication device may be attached to the sample collection kit such that the authentication device cannot be separated from the sample collection kit without mechanically damaging the same.

According to a further preferred embodiment of the invention, the sample collection kit has a control device, which is connected to the authentication device and adapted for controlling at least one of an alarm system, a mechanical blocking device and an electronic blocking device in dependency on an authentication based on the authentication data. Thereby the function of the authentication device can be monitored more easily and optionally automatable in an advantageous manner.

The control of at least one of the alarm system, the mechanical blocking device and the electronic blocking device preferably comprises a change of the operational state of the sample collection kit, like, for example, a blocking of at least one of its functions.

According to a preferred embodiment of the authentication arrangement, the test device is adapted for generating a control signal, by which at least one of an alarm system, a mechanical blocking device and an electronic blocking device is activatable depending on an authentication based on the authentication data. The control device of the sample collection kit may be particularly preferable coupled with the test device for receiving the control signal.

The alarm system is designed, for example, for an acoustically and/or visually perceptable alarm at the sample collection kit and/or remote of the same. The alarm system may be adapted for transmitting a signal to a central monitoring device. The mechanical blocking device is adapted for preventing a mechanical access to the sample collection kit. The mechanical blocking device, for example, comprises a mechanical latch blocking the sample collection kit in case the authentication result is negative, for example, closing the container device. The electronic blocking device is correspondingly adapted for blocking electrically actuated components of the sample collection kit. In case of a negative authentication result, the electronic blocking device may switch off electrically actuated components, like, for example, the data recording device.

In the following, further details and advantages of the invention are described by reference to the attached drawings. They schematically illustrate:

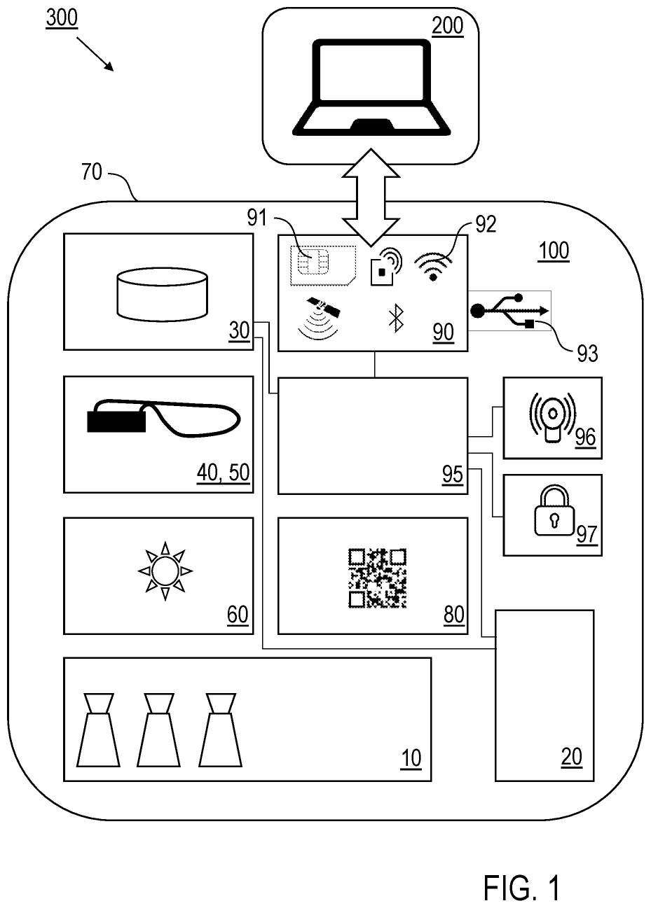

FIG. 1: a block diagram of a sample collection kit having features according to preferred embodiments of the invention;

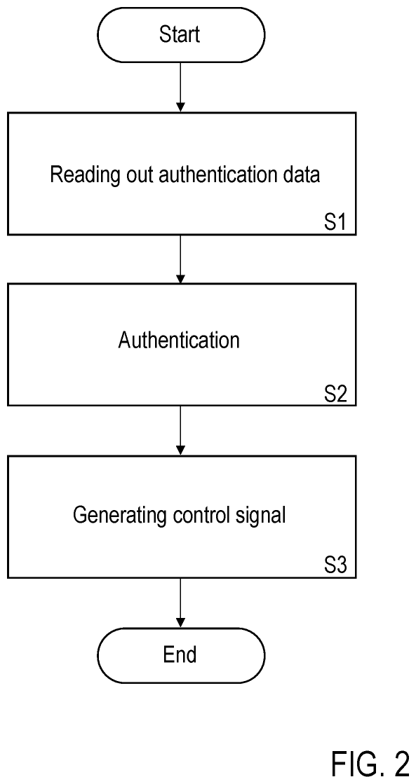

FIG. 2: a flowchart of methods for testing a state of a sample collection kit having features according to preferred embodiments of the invention; and

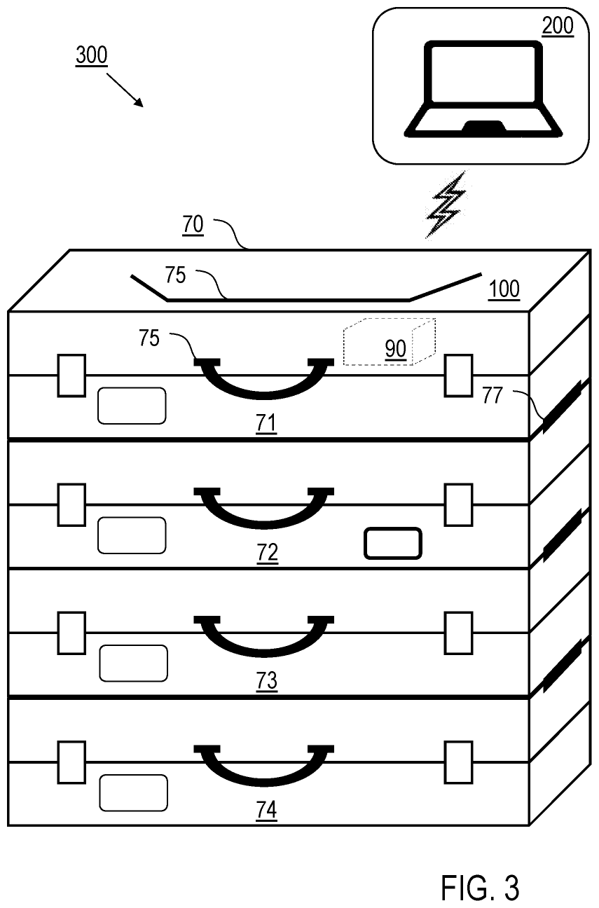

FIG. 3: a perspective view of a sample collection kit having a stack of multiple container modules.

In the following, features of preferred embodiments of the invention are described by an exemplary reference to a sample collection kit for collection of algae samples for the manufacture of alginate, as it is known from EP 3 257 586 A1. EP 3 257 586 A1 is hereby fully incorporated by reference in the present disclosure, in particular concerning the sample collection kit and its application, like, for example, the provision of the components of the sample collection kit and their properties.

As described in EP 3 257 586 A1, the algae samples are preferably obtained from macroalgae, in particular from the algae species Laminaria. However, the practice of the invention is not restricted to the sample collection kit from EP 3 257 586 A1 or an application in the collection of algae, but is correspondingly possible with other sample collection kits having a different configuration, for example, without the modular structure described in EP 3 257 586 A1 and/or a different application. The working materials for collecting algae samples contained in the sample collection kit are mentioned in an exemplary manner. In particular, the practice of the invention is not restricted to the application of the actually mentioned tools and auxiliary devices, but may also be realized with modified working materials adapted to the actual application. Details of collecting and processing of algae samples and the selection of suitable algae species are not discussed in the following, as far as the same are well known and common.

FIG. 1 is a schematic diagram of a sample collection kit 100 having features of preferred embodiments of the invention and a test device 200. Taken together, the sample collection kit 100 and the test device 200 represent an embodiment of an authentication arrangement 300 according to the invention. The test device 200 includes a computer, optionally having a display, which may be coupled with the sample collection kit 100 in a wired or wireless manner.

In preferred applications of the invention, the test device 200 is arranged at a distance from the sample collection kit 100. For example, one single test device 200 may be arranged for authentication of one or more sample collection kit(s) 100.

Alternatively, the test device 200 may be integrated in the sample collection kit 100. In this case, the authentication arrangement 300 is provided with the integrated test device 200 by the sample collection kit 100. The test device 200 may, for example, be provided by the control device 95 optionally included in the sample collection kit 100.

The control device 95 comprises a control circuit, like, for example, a computer circuit, wherein data of components of the sample collection kit 100 and/or control signals of the test device 200 are received, and control signals, in particular for a control of an alarm system 96 and/or a mechanical and/or electronic blocking device 97, are generated.

The sample collection kit 100 comprises a plurality of sample containers 10, like, for example, receptacle bags and/or receptacle bottles, in a container device 70. Before application of the sample collection kit 100 the sample containers 10, which are empty or prefilled with treatment liquids, are contained ready for reception in the sample collection kit 100. After collecting plant samples, the containers 10 filled with the plant samples are contained in the sample collection kit 100 or are contained in a separate collection container.

Furthermore, the sample collection kit 100 comprises a sensor device 20 in the container device 70, wherein the sensor device 20 is adapted for detecting external conditions in particular in the collection, transport and/or processing of plant samples, and includes at least one sensor. With the sensor device 20, for example, the temperature, the air humidity, the salt content in an external medium and/or in a sample container, the CO₂ content and/or a mechanical acceleration of the sample collection kit 100 may be detected. The sensor device 20 is coupled with a data recording device 30 and/or with the optionally provided control device 95.

Further components, such as the data recording device 30 and a tool arrangement 40, 50 as well as a device arrangement 60 with auxiliary devices, an energy storage device, like, for example, a rechargeable battery, and identification markings 80, may be contained in the container device 70 of the sample collection kit 100, as described in EP 3 257 586 A1. The data recording device 30 is coupled with the control device 95. Optionally, also electrically driven or electronic parts of the components 40, 50, 60 and 80 may be coupled with the control device 95.

The container device 70 may comprise one single container housing all components of the sample collection kit 100 together. Preferably, the container device 70 according to FIG. 3 comprises multiple container modules 71, 72, 73 and 74, in which the components of the sample collection kit 100, for example according to FIG. 1, are housed. In this case, which is also described in EP 3 257 586 A1, the sample collection kit 100 forms a case, which may be carried at handles 75 and which may be transported to the sample collection location manually.

According to the invention, the sample collection kit 100 contains at least one authentication device 90. The authentication device 90 is contained as a part of the sample collection kit 100 in the container device 70 and is preferably embeddedly arranged in the material of the container device 70 in a hidden manner, for example, cast in a plastic material of the container device 70. Alternatively or additionally, the at least one authentication device 90 is provided at one or more component(s) of the sample collection kit 100. The authentication device 90 is schematically shown in FIG. 3, wherein the dashed illustration symbolizes that the authentication device 90 is not recognizable by the user of the sample collection kit 100.

As schematically illustrated in FIG. 1, the authentication device 90 comprises an electronic data carrier 91 and a wireless interface 92 and/or a wired interface 93. The authentication device 90 is provided with electrical energy by the energy storage device (not shown) of the sample collection kit 100 or by an internal rechargeable battery. The energy supply may be carried out wired or inductively. The data carrier 91 is an electronic storage containing the authentication data, like, for example, a mobile radio SIM card. The stored authentication data comprise, for example, a list with a plurality of data characteristic for the original state of the sample collection kit 100. The same preferably include a service life duration of the sample collection kit 100 and/or a list of the components contained in the sample collection kit 100, for example, each with their identification data. Alternatively or additionally, further authentication data may be stored in the authentication device 90. The authentication data may be stored in the authentication device 90 in an encrypted manner.

The wireless interface 92 generally comprises an antenna for emitting electromagnetic radiation, typically in the radio frequency range, which is connected to the data carrier via a driver circuit. Alternatively, a wireless information transmission may be provided also by an optical connection, wherein in this case the wireless interface 91 is formed by a light source. Details of the wireless interface 91 are selected depending on the actual technical configuration. For example, a mobile radio antenna or a Bluetooth antenna is provided. The wired interface 92 comprises, for example, a USB port for coupling the test device 200 with the authentication device 90.

The implementation of the method for testing the state of the sample collection kit 100 is schematically illustrated in FIG. 2. First, the authentication data are read out from the authentication device 90 (step S1). The reading out comprises a transfer of the authentication data via the wireless interface 91 and/or the wired interface 92 to the test device 200.

Subsequently, an authentication of the sample collection kit 100 with the test device 200 is carried out, wherein the received authentication data are used (step S2). The authentication optionally comprises a decryption of the authentication data. The authentication data are then compared with reference data stored in the test device 200. If a match of the authentication data with the reference data is noted, the sample collection kit 100 is considered to be authenticated. In case of a positive authentication, an enabling signal may be generated as a control signal, which is designed, for example, for releasing a blocking device and/or for generating an optically and/or acoustically perceptable signal of the enabling of the sample collection kit 100.

In case deviations of the authentication data from the reference data are noted, preferably a blocking signal for activating the alarm system 96 and/or the blocking device 97 is generated as a control signal in order to exclude a further application of the sample collection kit 100 (step S3).

When the test device 200 is coupled with the control device 95 or is included in the same, the control signal may be generated by the control device 95. Differing from the illustration according to FIG. 1, the test device 200 may be directly coupled with the alarm system 96 and/or blocking device 97 in order to directly transmit the control signal.

Summarizing, the invention provides a sample collection kit having an electronic authentication function. For example, RFID beacons or similar readable data carriers are used to verify the authenticity of the sample collection kit. Testing the integrity of the kit may be carried out in two steps. In a first test it may be determined whether it is an original kit and its expiration date is not exceeded. In a second test it is checked whether the parts of the kit are matching, i.e., whether the same are original parts of the original kit. In case the authentication fails, a blocking of the kit or of a control device included in the kit may be provided. Furthermore, also a warning message may be generated.

For implementing the invention in its different embodiments, the features of the invention disclosed in the above description, the drawings and the claims may be both used alone as well as in a combination or sub-combination.

1-17. (canceled)

18. A sample collection kit adapted for collecting plant samples, comprising:
at least one sample container adapted to receive the plant samples;
a sensor arrangement having multiple sensors and configured to capture sample data;
a data recording device adapted to record the sample data;
a tool arrangement having collection tools, which are adapted for harvesting the plant samples, and having processing tools, which are adapted for processing the plant samples;
a container device adapted to receive the tool arrangement and the device arrangement in a state that is isolated from the surroundings;
identification markings that include identification data and are attached to the at least one sample container, the collection tools and the processing tools; and
an authentication device that includes an electronically readable data carrier with authentication data that represent a state of the sample collection kit, wherein
the authentication device is attached to at least one of the container device, the at least one sample container, the collection tools and the processing tools.

19. The sample collection kit according to claim 18, wherein
the authentication data of the electronically readable data carrier of the authentication device represent at least one of an original configuration of the sample collection kit and an expiration date of the sample collection kit.

20. The sample collection kit according to claim 18, wherein
the authentication device is adapted for storing encrypted authentication data.

21. The sample collection kit according to claim 18, wherein
the authentication device is adapted for a wired access to the authentication data.

22. The sample collection kit according to claim 18, wherein
the authentication device is adapted for a wireless read-out of the authentication data.

23. The sample collection kit according to claim 18, wherein
the authentication device comprises at least one of at least one RFID beacon, at least one mobile radio SIM card, at least one WLAN transmission-receiving unit, a satellite telephone unit and at least one Bluetooth beacon.

24. The sample collection kit according to claim 18, wherein
the authentication device is arranged in a hidden manner and is not visible when using the sample collection kit.

25. The sample collection kit according to claim 18, further comprising:
a control device connected with the authentication device and adapted to control at least one of an alarm system, a mechanical blocking device and an electronic blocking device depending on an authentication based on the authentication data.

26. The sample collection kit according to claim 18, wherein
the authentication device is provided additionally to the identification markings.

27. The sample collection kit according to claim 18, wherein
the authentication device is coupled with an interface for reading out the authentication data.

28. The sample collection kit according to claim 18, wherein
the authentication data represent an overall configuration of the sample collection kit as a connection of its components.

29. The sample collection kit according claim 18, wherein
the sample collection kit is adapted for collecting algae samples for biomedical applications.

30. An authentication arrangement adapted to test the state of a sample collection kit according to claim 18, comprising:
the sample collection kit containing the authentication device, and
a test device adapted to read out the authentication data and to authenticate the sample collection kit.

31. The authentication arrangement according to claim 30, wherein
the test device is adapted for a two-step authentication, comprising a first test of the original state of the at least one sample collection kit and an expiration date of the sample collection kit, and a second test of a matching of the parts of the sample collection kit.

32. The authentication arrangement according to claim 30, wherein
the test device is adapted to generate a control signal for activating at least one of an alarm system, a mechanical blocking device and an electronic blocking device depending on an authentication based on the authentication data.

33. The authentication arrangement according to claim 30, wherein
the test device is adapted to decrypt the authentication data.

34. A method for testing a state of a sample collection kit according to claim 18, comprising:
reading out the authentication data and authenticating the sample collection kit with a test device, and
generating a control signal, by which at least one of an alarm system, a mechanical blocking device and an electronic blocking device is activatable, depending on an authentication based on the authentication data.

35. The method according to claim 34, wherein
the authentication of the sample collection kit comprises a two-step authentication with a first test of the original states of the at least one sample collection kit and an expiration date of the sample collection kit, and a second test of a matching of the parts of the sample collection kit.
